(19) United States
(12) Patent Application Publication
(10) Pub. No.: US 2018/0048487 A1
(43) Pub. Date: Feb. 15, 2018

(54) METHOD FOR HANDLING NETWORK PARTITION IN CLOUD COMPUTING

(71) Applicant: ALCATEL-LUCENT CANADA INC., Ottawa (CA)

(72) Inventor: Qiuping Q. LI, Stittsville (CA)

(73) Assignee: ALCATEL-LUCENT CANADA INC.

(21) Appl. No.: 15/237,342

(22) Filed: Aug. 15, 2016

(51) Int. Cl. H04L 12/437; H04L 29/06; H04L 29/08

(52) U.S. Cl. CPC H04L 12/437; H04L 67/327; H04L 65/4076

(57) ABSTRACT

Various embodiments relate to a method, an active management node and a standby management node configured to detect and recover from a network partition the method including determining whether the active management node sees the standby management node on less than all of the plurality of token rings, then restarting the standby management node, determining whether a first active management node with a lower node index sees a second active management node with a higher node index on one or more than one of the plurality of token rings, then restarting the second active management node with a higher node index and determining whether the second active management node with a higher node index sees the second active management node with a lower node index on one or more than one of the plurality of token rings, then restarting the active management node with a higher node index.

### TECHNICAL FIELD

The disclosure relates generally to multi-ring carrier grade systems, and more specifically, but not exclusively, to detecting and resolving network partitions.

### RELATED APPLICATIONS

U.S. Patent Publication Number 2014/0280700 A1 describes a multi-ring reliable messaging system which is hereby incorporated by reference for all purposes as if fully set forth herein.

### BACKGROUND

A large distributed computing system can contain many inter-connected nodes built on top of a network. Network partitions happen when some of the nodes are disconnected from others unexpectedly due to software or hardware failures, extended delays, and congestion in the network or excessive packet loss. Network partitions could cause a system to split-brain, which indicates data and/or availability inconsistencies originating from the maintenance of two separate data sets.

Network partitions or split-brain has historically been a complicated problem to deal with when building a highly available and large scale distributed computing system. Handling this problem has become more challenging due to the fact that network topology becomes larger and more complicated due to virtualization and cloud technology.

High-availability clusters usually use a heartbeat private network connection which is used to monitor the health and status of each node in the cluster. For example, the split-brain syndrome may occur when all of the private links simultaneously fail, but the cluster nodes are still running, each one operating as if they are the only one running. The data sets of each cluster may then randomly operate by their own “idiosyncratic” data set updates, without any coordination with the other data sets.

While a cluster of cohesive nodes provide a complete set of services to the external entities or end users/customers, the inconsistent system viewed by each cluster node due to a network partition can cause serious service impact and in many cases system outages. With the emerging virtualization and cloud computing technologies, an increasing number of applications and services are moving into cloud environments to benefit from the cost reduction, among other benefits.

However, a virtualization layer adds extra delays and more possibilities of packet loss especially in a large scale system with hundreds or even thousands of inter-connected nodes. Temporary network disruption and network congestions are likely to happen frequently, whereby each disruption may last just a short period of time and then return to normal operation. Without an adequate network partition detection and automatic recovery mechanism, a large scale system could fail with only a brief period of time of network interruption.

One typical network partition or split-brain example is shown in FIGS. 1A and 1B as related art. FIG. 1A shows a cluster of application nodes 103 within a system 100. Application nodes 103 are providing different types of services. For example, application nodes 103 which are numbered 1, 2 and 3 are in a first grouping, application nodes 103 which are numbered 11, 12 and 13 are in a second grouping, and application nodes 103 which are numbered 21, 22 and 23 are in a third grouping. The management nodes 101 and 102 are specifically operating in active management node 101 and standby management node 102, respectively. In a normal operation, the active management node 101 monitors all the application nodes 103. The active management node 101 also connects and heartbeats with the standby management node 102, which takes over the activity should the active management node 101 fail. The lines between the nodes represent the active links or connections. Standby management node 102 can be connected with all other application nodes 103 but not be considered as active. The active management node 101 is also connected to the standby management node 102.

FIG. 1B illustrates one possible impact to the system 100 when there is a network partition. In this case, the connectivity between the active management node 101 and the standby management node 102 is broken. The standby management node 102 detects the loss of the active management node 101, then takes over the activity and begins an active role as an active management node. Some of the application nodes 103 are also disconnected from the active management node 101 and are connected with the standby management node 102. Further, some of the application nodes 103 are now seeing two active management nodes 101 and 102 (formerly a standby management node 102). As a result, the states in system 100 are inconsistent among different application nodes 103 and between the active management node 101 and standby management node 102.

There are several approaches to this problem in the prior art. The first approach is to have the two management nodes build a second physical path between each other to detect if the other node actually fails or if it is just isolated. For example, a second physical path can be built between the two management nodes by each entity reading/writing to a commonly accessible disk and having a constant handshake.

The second generally adopted approach is to have at least three or more management nodes in the system so that a quorum can be achieved among majority of the nodes. The first approach depends heavily on the hardware infrastructure which usually varies and unknown before a system is deployed. Furthermore, this approach cannot be adopted in the virtualization and cloud ecosystem due to hardware agnostic requirement for Virtualized Network Functions (VNFs). The second approach requires extra management nodes in the system which adds on to the costs of the product. Also, the quorum is achieved based on static information provisioned in the system; therefore, it is not flexible when a dynamically provisioned system is required.

### SUMMARY OF EMBODIMENTS

A brief summary of various embodiments is presented below. In order to overcome these and other shortcomings of the prior art and in light of the present need for a method for a network partition detection and automatic recovery mechanism, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a method for detecting and recovering from a network partition performed on a network having a multi-ring structure, the multi-ring structure having a plurality of token rings, an active management node, a standby management node and a plurality of application nodes, the method comprising determining whether the active management node sees the standby management node on less than all of the plurality of token rings, then restarting the standby management node, determining whether a first active management node with a lower node index sees a second active management node with a higher node index on one or more than one of the plurality of token rings, then restarting the second active management node with a higher node index and determining whether the second active management node with a higher node index sees the second active management node with a lower node index on one or more than one of the plurality of token rings, then restarting the active management node with a higher node index.

In an embodiment of the present disclosure, the method further comprises determining whether the standby management node sees the active management node on less than all of the plurality of token rings, then restarting the standby management node.

In an embodiment of the present disclosure, the method further comprises determining whether at least one of the plurality of application nodes is only connected to the standby management node or not connected to either of the active management node or the standby management node, then restarting the at least one of the plurality of application nodes.

In an embodiment of the present disclosure, the method further comprises determining whether the plurality of application nodes are only connected to the active management node, then not performing any action.

In an embodiment of the present disclosure, the method further comprises determining whether the plurality of application nodes are connected to the active management node and the standby management node, then not performing any action.

In an embodiment of the present disclosure, the method further comprises determining whether the active management node is active on all of the plurality of token rings, then not performing any action.

Various embodiments described herein relate to a method for detecting and recovering from a network partition performed on a network having a multi-ring structure, the multi-ring structure having a plurality of token rings, an active management node, a standby management node and a plurality of application nodes, the method comprising determining whether the standby management node sees the active management node on less than all of the plurality of token rings and restarting the standby management node.

In an embodiment of the present disclosure, the method further comprises receiving, by the standby management node, a broadcast message on one of the plurality of token rings from the active management node to restart the standby management node.

In an embodiment of the present disclosure, the method further comprises detecting, by the standby management node, a loss of the active management node and becoming the active management node.

In an embodiment of the present disclosure, the method further comprises determining whether the standby management node is standby on all of the plurality of token rings, then not performing any action.

Various embodiments described herein relate to an active management node, in a network having a multi-ring structure, the multi-ring structure having a plurality of token rings, a standby management node and a plurality of application nodes, the active management node comprising a processor, a non-transitory computer readable medium having program code stored thereon that is configured to, when executed by the processor, cause the processor to perform operations comprising determining whether the active management node sees the standby management node on less than all of the plurality of token rings, then restarting the standby management node, determining whether a first active management node with a lower node index sees a second active management node with a higher node index on one or more than one of the plurality of token rings, then restarting the second active management node with a higher node index and determining whether the second active management node with a higher node index sees the second active management node with a lower node index on one or more than one of the plurality of token rings, then restarting the active management node with a higher node index.

In an embodiment of the present disclosure, the active management node further causes the processor to further perform operations comprising determining whether the active management node is active on all of the plurality of token rings, then not performing any action.

Various embodiments described herein relate to a standby management node, in a network having a multi-ring structure, the multi-ring structure having a plurality of token rings, an active management node and a plurality of application nodes, the standby management node comprising a processor, a non-transitory computer readable medium having program code stored thereon that is configured to, when executed by the processor, cause the processor to perform operations comprising determining whether the standby management node sees the active management node on less than all of the plurality of token rings and restarting the standby management node.

In an embodiment of the present disclosure, the standby management node causes the processor to further perform operations comprising receiving, by the standby management node, a broadcast message on all of the plurality of token rings from the active management node to restart the standby management node.

In an embodiment of the present disclosure, the standby management node causes the processor to further perform operations comprising detecting, by the standby management node, a loss of the active management node and becoming the active management node.

In an embodiment of the present disclosure, the standby management node causes the processor to further perform operations comprising determining whether the standby management node is standby on all of the plurality of token rings, then not performing any action.

Various embodiments described herein relate to a system for detecting and recovering from a network partition performed on a network having a multi-ring structure, the multi-ring structure having a plurality of token rings, an active management node, a standby management node and a plurality of application nodes, the system comprising a processor and a non-transitory computer readable medium having program code stored thereon that is configured to cause the processor to determine whether the standby management node sees the active management node on less than all of the plurality of token rings, then restarting the standby management node; determine whether the active management node sees the standby management node on less than all of the plurality of token rings, then restarting the standby management node; determine whether a first active management node with a lower node index sees a second active management node with a higher node index on one or more than one of the plurality of token rings, then restarting the second active management node with a higher node index; and determine whether the second active management node with a higher node index sees the second active management node with a lower node index on one or more than one of the plurality of token rings, then restarting the active management node with a higher node index.

In an embodiment of the present disclosure, the processor being further configured to determine whether at least one of the plurality of application nodes is only connected to the standby management node or not connected to either of the active management node or the standby management node, then restarting the at least one of the plurality of application nodes.

In an embodiment of the present disclosure, the processor being further configured to determine whether the standby management node sees the active management node on less than all of the plurality of token rings, then restarting the standby management node.

In an embodiment of the present disclosure, the processor being further configured to receive, by the standby management node, a broadcast message on one of the plurality of token rings from the active management node to restart the standby management node.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

These and other more detailed and specific features of the present invention are more fully disclosed in the following specification, reference being had to the accompanying drawings, in which:

FIG. 1A is a diagram of a conventional system network topology.

FIG. 1B is a diagram of a network partition.

FIG. 2 is a diagram of a multi-ring carrier grade system.

FIG. 3A is a diagram of a multi-ring carrier grade system network topology.

FIG. 3B is a diagram of a network partition sample.

FIG. 4 is a diagram of a network topology for cloud applications.

FIG. 5 is a flow chart of the method for detecting and recovering from a network partition.

FIG. 6 is a diagram of a network partition and recovery.

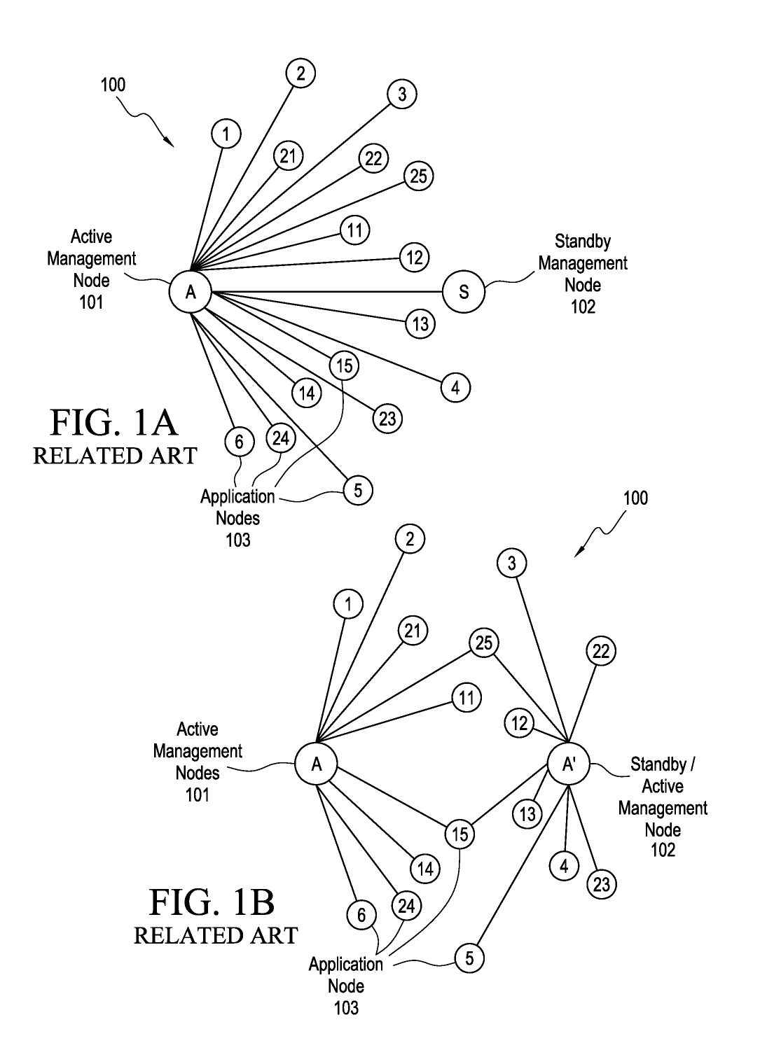

### DETAILED DESCRIPTION OF THE INVENTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. As used herein, the terms “context” and “context object” will be understood to be synonymous, unless otherwise indicated. Descriptors such as “first,” “second,” “third,” etc., are not meant to limit the order of elements discussed, are used to distinguish one element from the next, and are generally interchangeable.

In general, the multi-ring carrier grade system is a plurality of interconnected token rings configured to implement a multi-ring reliable messaging system. It will be appreciated that the plurality of token rings interconnected to implement a reliable system may be a subset of the available token rings (e.g., a subset of the token rings in a system in which the multi-ring reliable messaging capability is provided).

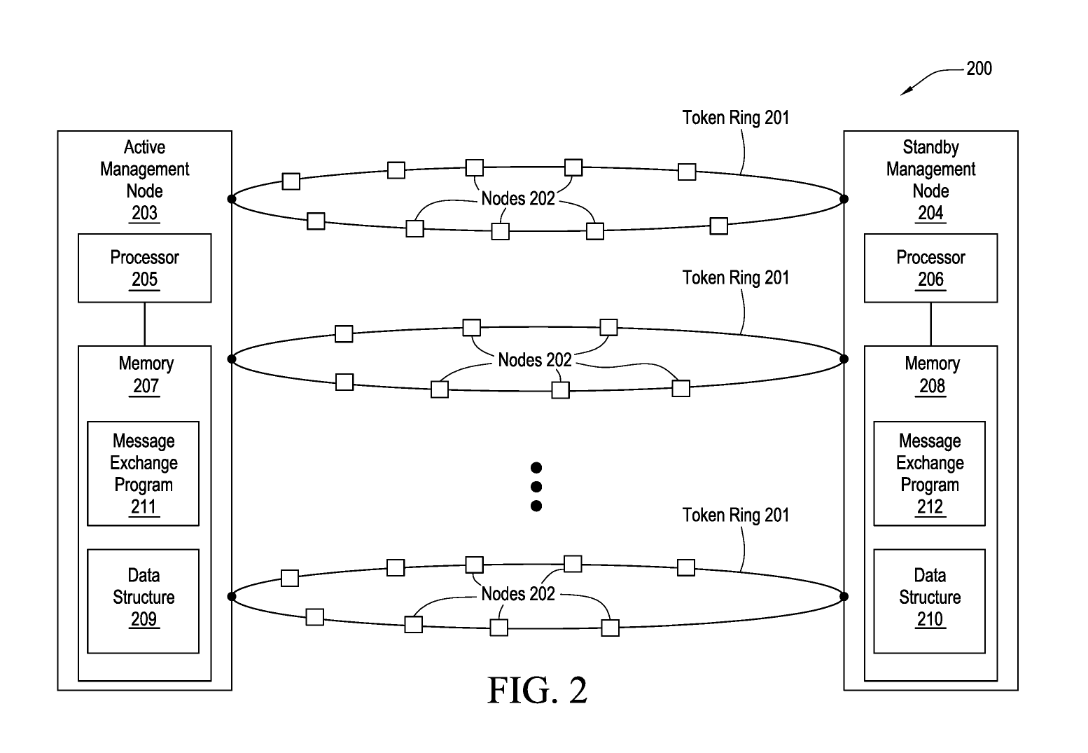

FIG. 2 illustrates a multi-ring carrier grade system 200 which may be formed by interconnecting a plurality of token rings 201 via a pair of management nodes that includes an active management node 203 that is configured to communicate with each of the plurality of token rings 201 and a standby management node 204 that also is configured to communicate with each of the plurality of token rings 201, when the active management node 203 fails.

The active management node 203 is configured to receive an original message through a token ring 201 and propagate one or more associated messages toward one or more other token rings 201 for which the original message is intended. The active management node 203 is configured to receive an original message through a token ring 201, determine one or more other token rings 201 to which the original message is to be provided, generate one or more associated messages for the one or more other token rings 201 to which the original message is to be provided, and propagate the one or more associated messages toward the one or more other token rings 201.

The standby management node 204 is configured to monitor for original and associated messages received through the token rings 201 in a manner for preventing loss of messages when the active management node 203 fails. The standby management node 204 is configured to receive, from a token ring 201, an original message generated by an application node 202 of the token ring 201, store the original message, and monitor for receipt of one or more associated messages, associated with the original message, from one or more other token rings 201.

A multi-ring carrier grade system 200 is organized such that the application nodes 202 of the multi-ring carrier grade system 200 are grouped based on respective application node types (e.g., for each application node type in the multi-ring carrier grade system 200, the application nodes 202 are grouped into one or more token rings 201 for the respective application node type). Grouping of application nodes 202 into the token rings 201 based on respective application node types may be used to ensure that total-order delivery of messages is supported between application nodes 202 of the same application node type (within the respective token rings 201) while only causal-order delivery of messages needs to be supported between application nodes 202 of different application node 202 types (between the token rings 201).

A multi-ring carrier grade system 200 facilitates horizontal scalability while retaining various benefits associated with use of token rings 201 for message delivery (e.g., reliable message delivery, fast reaction times, and the like). It will be appreciated that horizontal scalability overcomes existing limitations of token ring 201 networks in terms of the number of application nodes 202 which may be supported.

The active management node 203 includes a processor 205 and a memory 207 that is communicatively connected to the processor 205. The memory 207 stores a message exchange program 211 that, when executed by processor 205, causes the processor 205 to perform various functions of the active management node 203 as depicted and described herein. The memory 207 also may store a data structure 209 (e.g., a linked list or other suitable type of data structure) which may be used by the active management node 203. If the active management node 203 functions in a standby role after recovering from a failure in which the standby management node 204 assumed the active role in response to the failure of the active management node 203.

The standby management node 204 includes a processor 206 and a memory 208 that is communicatively connected to processor 206. The memory 208 stores a message exchange program 212 that, when executed by the processor 206, causes the processor 206 to perform various functions of the standby management node 204 as depicted and described herein. The memory 208 also may store a data structure 210 (e.g., a linked list or other suitable type of data structure) for use in performing various functions of the standby management node 204 as depicted and described herein.

The data structure 210 of standby management node 204 is configured for use in preserving the order of messages for each of the token rings 201. The data structure 210 may be used to store messages received at standby management node 204 from token rings 201 for messages that originate from the token rings 201. The data structure 210 may be used to track messages received at standby management node 204 from token rings 201 for messages that do not originate from the token rings 201 on which the messages are received (i.e., messages generated and provided to the token rings by active management node 203). The data structure 210 may be implemented as or include a linked list(s) or any other type(s) of data structure(s) suitable for use in storing and tracking messages as discussed above.

Thus, for the purposes of clarity, interfacing between the processors 205, 206 of the management nodes 203, 204 and the token rings 201 are depicted as respective sets of communication paths between the management nodes 203, 204 and the respective plurality of token rings 201.

The operation of the active management node 203 and the standby management node 204 differs based on their status as being in an active state and or a standby state, respectively.

The standby management node 204 is configured to ensure that messages are not lost if the active management node 203 fails. The standby management node 204 receives the same messages that are received by active management node 203 (as they are both members of the plurality of the token rings 201), which include original messages that originate on the token rings 201 and associated messages that are generated by the active management node 203 and provided to the token rings 201.

As noted herein, the multi-ring carrier grade system 200 may be implemented within various types of environments, contexts and systems.

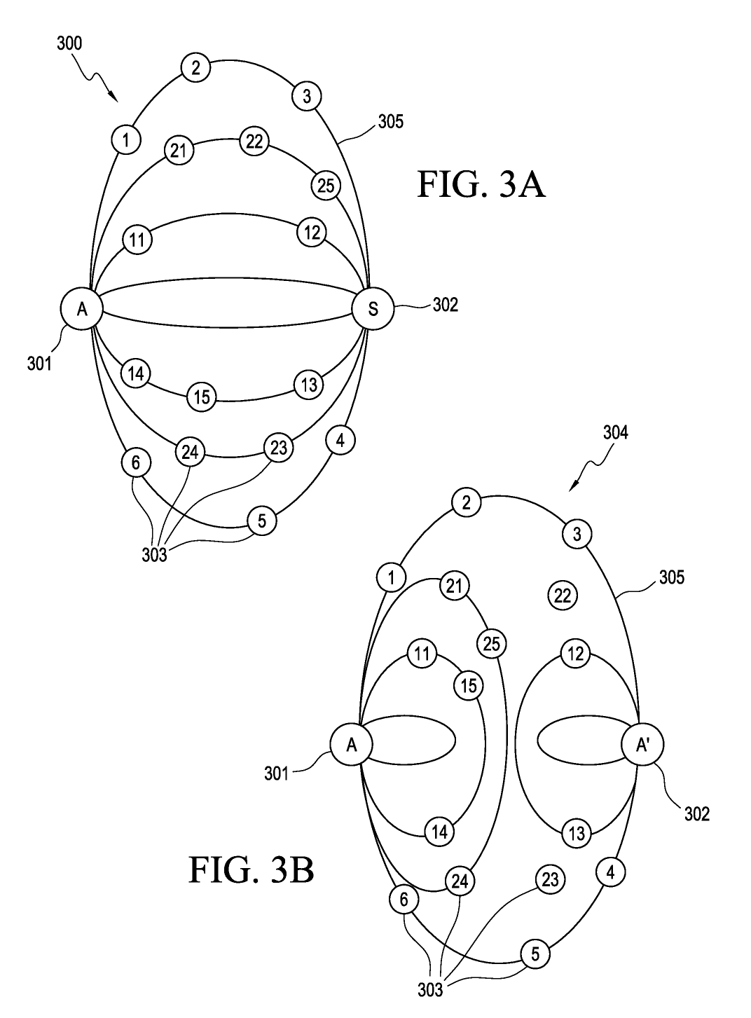

Various embodiments of the multi-ring carrier grade system 200 may be better understood by way of reference to FIGS. 3A and 3B.

FIG. 3A is a network topology of a multi-ring carrier grade system 300. The multi-ring carrier grade system 300 includes a plurality of token rings 305 and a pair of management nodes including an active management node 301 and a standby management node 302.

The token rings 305 include respective pluralities of application nodes 303. Within a given token ring 305, the application nodes 303 of the token ring 305 are communicatively connected in a ring architecture. The application nodes 303 in the token rings 305 may be organized based on the application node types. In at least some embodiments, the token rings 305 and associated application nodes 303 may be organized such that, for N application node 303 to be supported within multi-ring carrier grade system 300, application nodes 303 having the same application node type are grouped together to form the token rings 305, respectively (namely, application nodes of a first token ring are nodes of a first node type, nodes of a second token ring are nodes of a second node type, and so forth).

It will be appreciated that, although primarily depicted and described with respect to a one-to-one relationship between application nodes 303 and the token rings 305, the token rings 305 and associated application nodes 303 may be organized using other arrangements (e.g., multiple node types may be combined within a single token ring 305, application nodes 303 of a given node type may be organized into a plurality of token rings 305, or the like, as well as various combinations thereof). It will be appreciated that, in at least some embodiments, application nodes 303 of a given application node type may only be distributed across multiple token rings 305 if there is not a requirement for total-order delivery of messages to the application node 303 of the given application node type (e.g., delivery of messages may only be provided in causal-order between application nodes 303 of the respective token rings 305 for the node type). Accordingly, it will be appreciated that the numbers of application nodes 303 in the token rings 305 may vary across the token rings 305.

The token rings 305 include respective sets of application nodes 303. Within a given token ring 305, the application nodes 303 of the token ring 305 are configured to generate messages, propagate generated messages to other application nodes 303 of the token ring 305, process messages received from other application nodes 303 of the token ring 305, forward messages received from other application nodes 303 of the token ring 305, and the like. In general, a message generated by an application node 303 of a token ring 305 is considered to have originated from that token ring 305 (and may be referred to as an original message of that token ring 305). With a given token ring 305, the application nodes 303 of the token ring 305 are configured to support a token ring 305 protocol which facilitates exchanging of messages between the application nodes 303 of that token ring 305.

The token rings 305 also include each of the management nodes 301, 302. Each of the management nodes 301, 302 are configured to interface with each of the token rings 305. More specifically, the management nodes 301, 302 are each included within the token ring 305 architectures of each of the token rings 305, such that each of the management nodes 301, 302 receives each message that is exchanged on each of the token rings 305. In this sense, each of the management nodes 301, 302 appear as a “node” on each token ring 305 (although the presence of the management nodes 301, 302 within the token rings 305 may be transparent to the application nodes 303 of the token rings 305). The token rings 305 operate independently of each other with the exception of the gateways which integrate the token rings 305 in a manner enabling exchanging of messages between token rings 305. The active management node 301 and the standby management node 302 may be deployed based on anti-affinity rules in order to ensure (or at least increase the likelihood) that both the active management node 301 and the standby management node 302 do not fail at the same time (e.g., using geographic diversity, platform diversity, or the like).

FIG. 3B is a network topology of a multi-ring carrier grade system 304 with a network partition. As shown in FIG. 3B, when a network partition occurs, token rings 305 can be broken into smaller token rings 305 and application nodes 303 can be isolated or partially connected from the rest of the multi-ring carrier grade system 304. As discussed above, FIG. 3A illustrates a set of properly connected token rings 205 in a functioning network. As discussed above, FIG. 3B illustrates an example of one of many possible outcomes when there is a network partition in the multi-ring carrier grade system 304.

For example, when the active management node 301 is disconnected, the standby management node 302 becomes active (i.e. the standby management node becomes an active management node). A plurality of the application nodes 303 remain on the same token rings which are connected to the active management node 301, while other application nodes 303 move to the new active management node 302. Select application nodes 303 are isolated completely from the rest of the multi-ring carrier grade system 304.

Furthermore, for example, select application nodes 303 are now connected with both active management nodes 301, 302 on a single token ring 305, namely, the active management nodes 301, 302. The state of the multi-ring carrier grade system 304 becomes inconsistent among application nodes 303 as well as between the two active management nodes 301, 302.

In this example, the inconsistent system view may cause adversarial impact to the entire multi-ring carrier grade system 304 and therefore trigger system Key Performance Index (KPI) degradation and possible network outages.

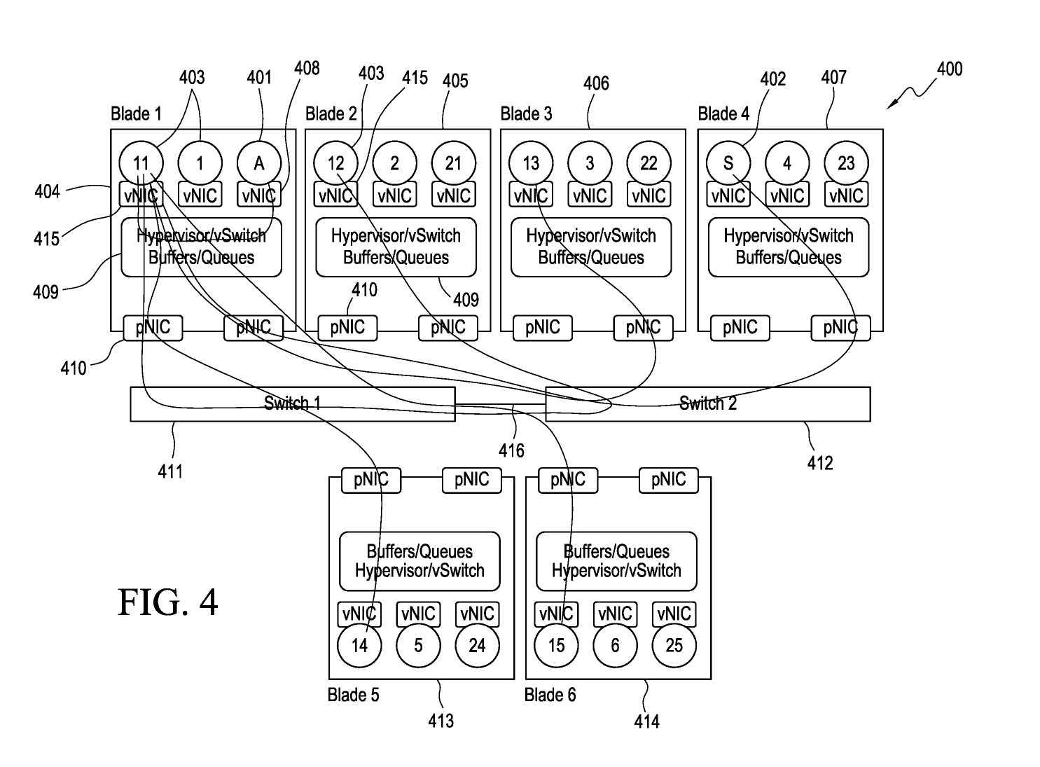

FIG. 4 is an embodiment of a sample network topology for cloud applications. In a virtualized and cloud system 400, the added hypervisor software layer and extra delay/latency could make the network partition and split-brain problem more severe and occur more frequently. FIG. 4 illustrates a typical network topology when deploying application software in a cloud based system 400.

Each application node 403 runs inside a virtual machine (VM) which has a number of virtual network interfaces (vNICs) 415 attached. One blade 404, 405, 406, 407, 413, 414 may contain multiple virtual machines. Each blade 404, 405, 406, 407, 413, 414 also runs a hypervisor and virtual switch 409 software for internal message switching and buffering. Multiple layer switch blades 411, 412 are connected with blades' physical network interfaces (pNICs) 410 for routing traffic between blades 404, 405, 406, 407, 413, 414 as well as for routing traffic towards external networks. The switch blades 411, 412 may be inter-connected through Intelligent Resilient Framework (IRF) links 416.

A message sent from one application node 403 to another usually travels through many software and hardware components. For example, a message sent from an application node 403 in Blade 1 to an application node 403 in Blade 2 needs to go through several software and hardware components in sequence: application node 403 in Blade 1 vNIC 415, Blade 1 hypervisor/vSwitch 409, Blade 1 pNIC 410, Switch 1 411, IRF link 416, Switch 2 412, Blade 2 pNIC 410, Blade 2 hypervisor/vSwitch 409 and the application node 403 in Blade 2 vNIC 415.

Any failure or delay that happens on this path can cause network partition. Furthermore, for example, if Switch 2 blade 412 fails or delays forwarding the traffic, the network partition (as shown in FIG. 3B) can occur. Network partitions happen within a short period of time (e.g. on the order of a few seconds), but the impact can be lasting if the network partition is not detected and recovered. In this case, an application node 403 restart will likely trigger the rediscovery of proper network topology and bring the system back to a normal operation.

As shown in FIG. 4, the two management nodes, active management node 401 and standby management node 402 are on every ring which spans over different token rings. It is possible to enforce the diversity of message paths by purposely choosing a different vNIC 415 for carrying the internal messages in different VMs and configuring pNICs 410 on each blade to run in active-active mode.

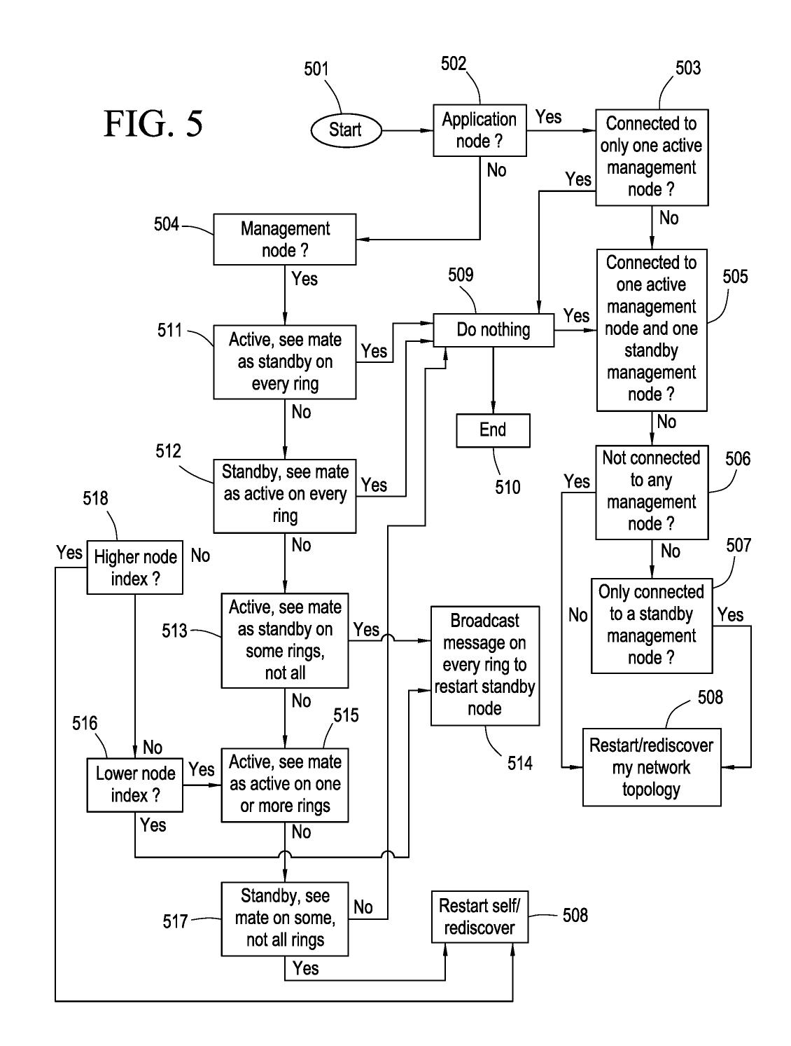

An embodiment of a method which may be executed by the processor of the active management node is depicted and described with respect to FIG. 5. It will be appreciated that any other combinations of functions depicted and described herein may be implemented as one or more processes configured for execution by the processor of the active or standby management node.

FIG. 5 is a flow chart illustrating an example of a method 500 for detecting and resolving a network partition in a multi-ring carrier grade system (e.g. the system in FIG. 2).

The example method 500 begins in step 501 where the first step is to make a determination as to whether the node is an application node or a management node by proceeding to step 502 where it is determined whether the node is an application node. If yes, the method 500 proceeds to step 503. If no, the example method 500 proceeds to step 504.

Step 503 determines whether the application node is connected to only one active management node. If yes, the application node is directed to not perform any action 509 and end the example method 510. If no, the example method proceeds to step 505.

Step 505 determines whether the application node is connected to one active management node and one standby management node. If yes, the application node is directed to not perform any action 509 and end the example method 510. If no, the example method proceeds to step 506.

Step 506 determines whether the application node is not connected to any management node. If yes, the application node is directed to restart and rediscover the network topology 508. If no, the example method proceeds to step 507.

Step 507 determines whether the application node is only connected to a standby management node. If yes, the application node is directed to restart and rediscover the network topology 508. If no, the application node is directed to not perform any action 509 and end the example method 510.

Step 504 determines whether the node is a management node. If no, the example method 500 returns to the start of the example method 500. If yes, the example method 500 proceeds to step 511.

Step 511 determines whether the management node is an active management node and whether the active management node can see the standby management node on every token ring. If yes, the application node is directed to not perform any action 509 and end the example method 510. If no, the example method 500 proceeds to step 512.

Step 512 determines whether the management node is a standby management node and whether the standby management node can see the active management node on every token ring. If yes, the application node is directed to not perform any action 509 and end the example method 510. If not, the example method 500 proceeds to step 513.

Step 513 determines whether the management node is an active management node and whether the active management node sees the standby management node on less than all of the token rings. If yes, the example method 500 proceeds to step 514 which instructs the active management node to broadcast a message on every token ring to inform the standby management node to restart and rediscover the network topology 514. If no, the example method 500 proceeds to step 515.

Step 515 determines whether the management node is an active management node and whether the active management node sees the standby management node as active on one or more token rings. If no to step 515, the example method proceeds to step 517. If yes to step 515, the example method proceeds to step 516 to determine whether the active management node has a lower node index. For example, each management node has an index number; therefore, in step 516 the active management node has an index number which is being compared to the other management node to determine whether the index number is lower. If yes to step 516, the active management node is directed to broadcast a message on every token ring to inform the standby management node to restart and rediscover the network topology 514. If no to step 516, the example method 500 proceeds to step 518 to determine if the active management node has a higher node index. For example, each management node has an index number; therefore, in step 518 the active management node has an index number which is being compared to the other management node to determine whether the index number is higher. If yes to step 518, the example method 500 proceeds to step 508 to restart and rediscover the network topology 508. If no to step 518, the active management node is directed to not perform any action 509 and end the example method 510.

Step 517 determines whether the management node is standby management node and if the standby management node can see the active management node as active on less than all of the token rings. If yes, the example method 500 proceeds to step 508 to restart and rediscover the network topology 508. If no, the active management node is directed to not perform any action 509 and end the example method 510.

With this logic built in as part of base software distributed on every node of the cluster, a network partition can be detected quickly and dynamically, and therefore recovery actions may be triggered immediately. The algorithm is built within a base layer which brings the benefits of a zero impact on application software and can be easily adopted by a variety of different application systems.

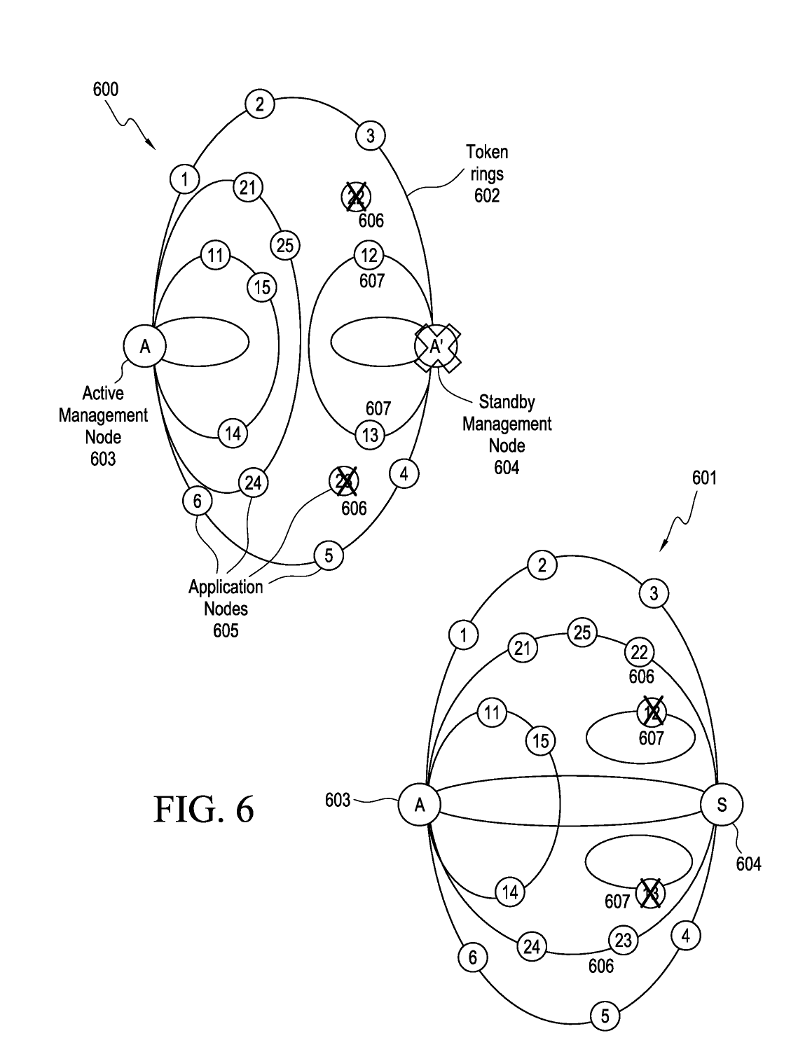

FIG. 6 illustrates a solution to detecting a network partition and recovering from the failure and delay, specifically, by making use of the multi-ring structure. FIG. 6 illustrates an example of step 517 in FIG. 5 based upon a real world scenario.

Prior to implementing the logic in FIG. 5, the system 600 was running and providing services for months before a short network interruption/delay happened which only lasted a few seconds but was long enough for a corosync ring to declare a number of node failures while those nodes were actually running but temporarily lost the connectivity.

The original state of the system 300 is illustrated FIG. 3A. A short network interruption caused the system 301 to partition as shown in FIG. 3B. The system 600 (same as system 301) stayed in that state for hours with inconsistent states among application nodes and therefore caused hours of long partial outages and service impacts.

As seen in FIG. 6, system 600 includes nodes 606 which are separated from the system and not connected to any token ring 602. Furthermore, nodes 607 are connected to a token ring 602 which is connected to the standby management node 604, however, is not connected to the active management node 603.

After this incident, the logic from FIG. 5 was implemented into the system. The same temporary network interruption happened again, however, the system automatically recovered to the proper network topology and states after going through the recovery process.

As seen in step 517 of FIG. 5, the network partition was detected by the standby management node 604 which saw the active management node only on a single token ring and not on all of the token rings. At the same time, application nodes 606 lost connectivity to the management nodes 603, 604. As stated in the logic in FIG. 5, the standby management node 604 and the nodes 606 were restarted to trigger a network rediscovery. Immediately after the standby management node 604 restarted, nodes 607 lost connectivity and became isolated, therefore, following step 506 in FIG. 5, the application nodes 606 triggered the restart and rediscovered the network topology. As a result of this cascade effect, the entire system recovered to the original state as shown in FIG. 3A.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for detecting and recovering from a network partition performed on a network having a multi-ring structure, the multi-ring structure having a plurality of token rings, an active management node, a standby management node and a plurality of application nodes, the method comprising:
determining whether the active management node sees the standby management node on less than all of the plurality of token rings, then restarting the standby management node;
determining whether a first active management node with a lower node index sees a second active management node with a higher node index on one or more than one of the plurality of token rings, then restarting the second active management node with a higher node index; and
determining whether the second active management node with a higher node index sees the second active management node with a lower node index on one or more than one of the plurality of token rings, then restarting the active management node with a higher node index.

2. The method of claim 1, further comprising:
determining whether the standby management node sees the active management node on less than all of the plurality of token rings, then restarting the standby management node.

3. The method of claim 1, further comprising:
determining whether at least one of the plurality of application nodes is only connected to the standby management node or not connected to either of the active management node or the standby management node, then restarting the at least one of the plurality of application nodes.

4. The method of claim 1, further comprising:
determining whether the plurality of application nodes are only connected to the active management node, then not performing any action.

5. The method of claim 1, further comprising:
determining whether the plurality of application nodes are connected to the active management node and the standby management node, then not performing any action.

6. The method of claim 1, further comprising:
determining whether the active management node is active on all of the plurality of token rings, then not performing any action.

7. A method for detecting and recovering from a network partition performed on a network having a multi-ring structure, the multi-ring structure having a plurality of token rings, an active management node, a standby management node and a plurality of application nodes, the method comprising:
determining whether the standby management node sees the active management node on less than all of the plurality of token rings; and
restarting the standby management node.

8. The method of claim 7, further comprising:
receiving, by the standby management node, a broadcast message on one of the plurality of token rings from the active management node to restart the standby management node.

9. The method of claim 7, further comprising:
detecting, by the standby management node, a loss of the active management node and becoming the active management node.

10. The method of claim 7, further comprising:
determining whether the standby management node is standby on all of the plurality of token rings, then not performing any action.

11. An active management node, in a network having a multi-ring structure, the multi-ring structure having a plurality of token rings, a standby management node and a plurality of application nodes, the active management node comprising:
a processor;
a non-transitory computer readable medium having program code stored thereon that is configured to, when executed by the processor, cause the processor to perform operations comprising:
determining whether the active management node sees the standby management node on less than all of the plurality of token rings, then restarting the standby management node;
determining whether a first active management node with a lower node index sees a second active management node with a higher node index on one or more than one of the plurality of token rings, then restarting the second active management node with a higher node index, and
determining whether the second active management node with a higher node index sees the second active management node with a lower node index on one or more than one of the plurality of token rings, then restarting the active management node with a higher node index.

12. The active management node of claim 11, causing the processor to further perform operations comprising:
determining whether the active management node is active on all of the plurality of token rings, then not performing any action.

13. A standby management node, in a network having a multi-ring structure, the multi-ring structure having a plurality of token rings, an active management node and a plurality of application nodes, the standby management node comprising:
a processor;
a non-transitory computer readable medium having program code stored thereon that is configured to, when executed by the processor, cause the processor to perform operations comprising:
determining whether the standby management node sees the active management node on less than all of the plurality of token rings, and
restarting the standby management node.

14. The standby management node of claim 13, causing the processor to further perform operations comprising:
receiving, by the standby management node, a broadcast message on all of the plurality of token rings from the active management node to restart the standby management node.

15. The standby management node of claim 13, causing the processor to further perform operations comprising:
detecting, by the standby management node, a loss of the active management node and becoming the active management node.

16. The standby management node of claim 13, causing the processor to further perform operations comprising:
determining whether the standby management node is standby on all of the plurality of token rings, then not performing any action.

17. A system for detecting and recovering from a network partition performed on a network having a multi-ring structure, the multi-ring structure having a plurality of token rings, an active management node, a standby management node and a plurality of application nodes, the system comprising:
a processor; and
a non-transitory computer readable medium having program code stored thereon that is configured to cause the processor to:
determine whether the standby management node sees the active management node on less than all of the plurality of token rings, then restarting the standby management node;
determine whether the active management node sees the standby management node on less than all of the plurality of token rings, then restarting the standby management node;
determine whether a first active management node with a lower node index sees a second active management node with a higher node index on one or more than one of the plurality of token rings, then restarting the second active management node with a higher node index; and
determine whether the second active management node with a higher node index sees the second active management node with a lower node index on one or more than one of the plurality of token rings, then restarting the active management node with a higher node index.

18. The system of claim 17, the processor being further configured to:
determine whether at least one of the plurality of application nodes is only connected to the standby management node or not connected to either of the active management node or the standby management node, then restarting the at least one of the plurality of application nodes.

19. The system of claim 17, the processor being further configured to:
determine whether the standby management node sees the active management node on less than all of the plurality of token rings, then restarting the standby management node.

20. The system of claim 17, the processor being further configured to:
receive, by the standby management node, a broadcast message on one of the plurality of token rings from the active management node to restart the standby management node.
